(19) United States
(12) Patent Application Publication
(10) Pub. No.: US 2025/0308402 A1
(43) Pub. Date: Oct. 2, 2025

(54) QUESTION GENERATION FROM RECEIVED INPUT

(71) Applicant: Lenovo (United States) Inc., Morrisville, NC (US)

(72) Inventors: Tyler Nicholls, Lehi, UT (US); Inna Zolin, Cary, NC (US); Matthew Fardig, Boonville, IN (US); Joshua Smith, Milton, FL (US)

(21) Appl. No.: 18/619,763

(22) Filed: Mar. 28, 2024

(51) Int. Cl. G09B 7/07; G10L 15/26

(52) U.S. Cl. CPC G09B 7/07; G10L 15/26

(57) ABSTRACT

The private driveshare passenger transportation system allows a car service to offer a brand new option to consumers where it mimics the experience of hiring an hourly car service, to a degree, but is less costly as it implements conditions that allows the company to provide additional service within the specified timeframe to separate groups or individuals, outside of and in between the times they are transporting the private driveshare passenger transportation system customer. Today's car services, in example, taxis, rideshares, limousines, and hourly service operations, offer on-demand ride requests, predetermined ride requests put on a schedule, and full service, hourly accommodations. The former services mentioned allow a company to accommodate multiple parties with one vehicle and one driver with limited availability until a potential new vehicle and driver are utilized as there is no manner of predicting where the original vehicle and driver may end up due to the vast radius' these vehicles are able to travel to, and the opportunity cost of turning down longer distance ride requests is too high. This is where a second vehicle and driver may be available to accommodate the parties staying relatively local and the availability of these vehicles could still remain limited. The latter services mentioned provide local service to one group for an extended period of time at a premium hourly cost in comparison to the by-the-ride service rates for maximum reliability. The key difference in the new system compared to all of the others is the level of knowledge and control provided to the consumer placing a deposit for a timeframe or multiple timeframes within a day or evening, also known as the private driveshare passenger transportation system customer. The system provides the consumer with the same driver and vehicle and allows the transportation company to provide service to other groups or individuals with decisive plans of similar geographic areas known by the group or individual placing the timeframe deposit; whether they know a portion of that vehicle and driver's schedule prior to placing the deposit, or subsequently accepting or denying new requests that come in after the deposit is made. The knowledge of the same vehicle and driver's already established outside ride schedule is provided as well as the control and opportunity of new requests that may arise after the deposit is made for a specific timeframe is traded for the lower cost in comparison to hire the service at an hourly rate. In addition to the deposits made prior to the day of service, private driveshare passenger transportation system customers pay for each individual ride at a variable cost based on the number of outside rides they agree to work around. Other services do not offer the same flexibility with the same vehicle and driver. This system provides an opportunity to be able to schedule groups and individuals at by-the-ride ratings, while also offering a group or individual a more flexible and less expensive option than hiring the service at a more expensive hourly rate. This invention provides the opportunity for a company to potentially earn more than they would than if they were just offering hourly or by-the-ride options.

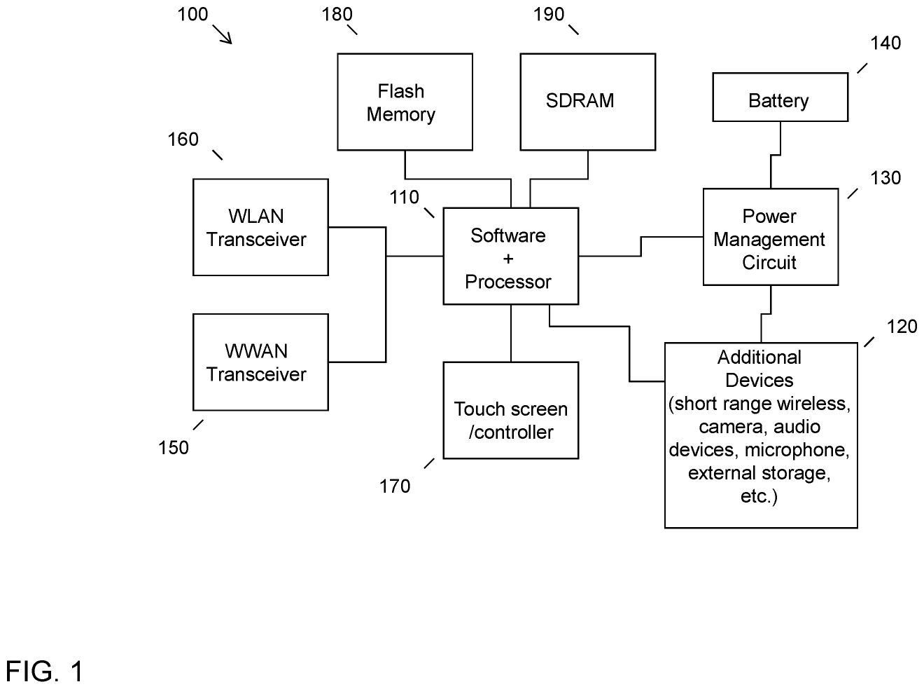

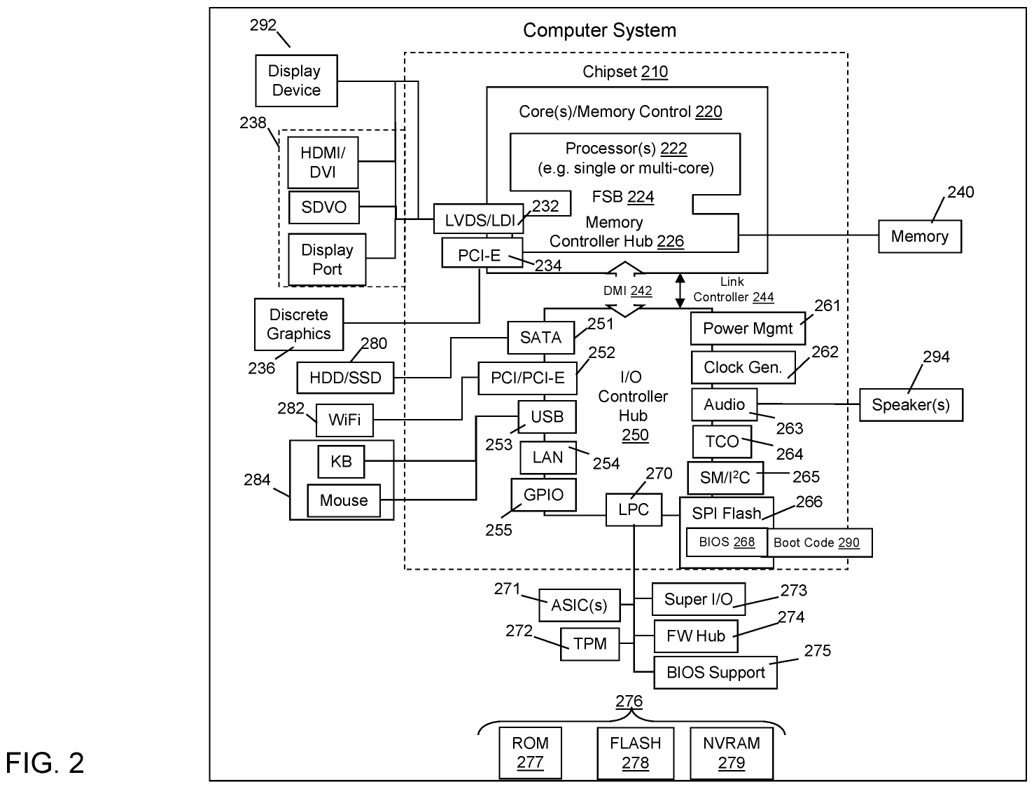

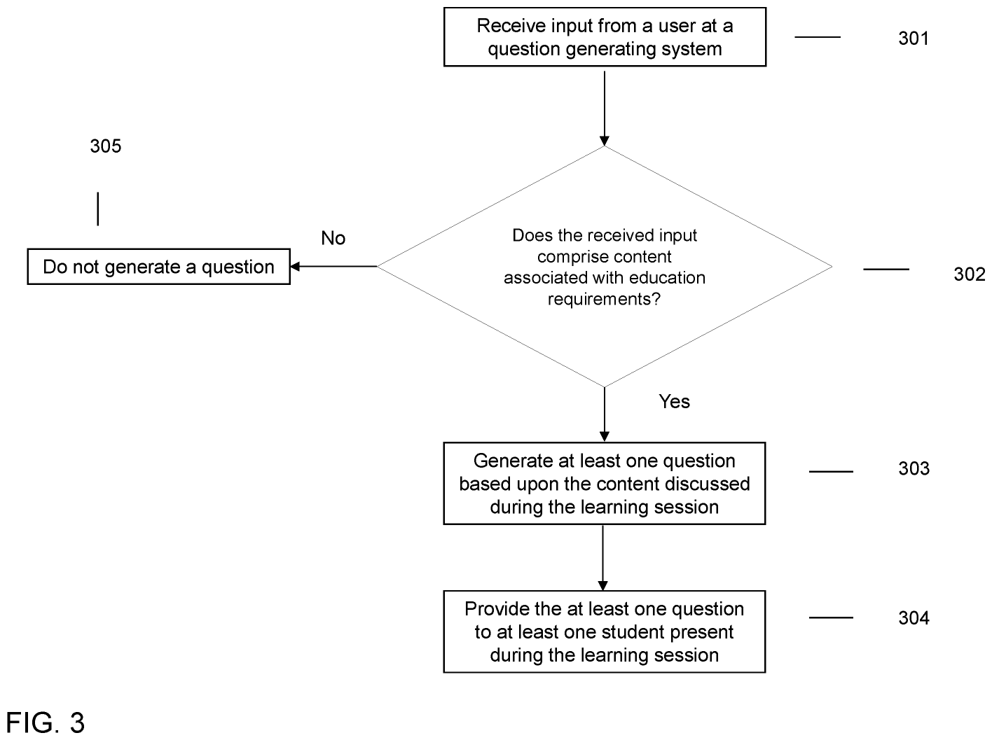

### TECHNICAL SUMMARY OF THE PATENT

The step-by-step process of utilizing the private driveshare passenger transportation system: Please note, to shorten the description and labeling of the private driveshare passenger transportation system customer, going forward, these customers are subsequently referred to as the private driveshare customer.

There are many scenarios that can occur in the scheduling process. This example best explains how the service would operate:

Prospect A calls in for passenger transportation service looking to go to multiple destinations from and ultimately back to their origin location.

Step 1—Check the desired date for availability and offer the following three options accordingly
1. By-the-ride service: a full plan is needed consisting of time and location-specific pick up information. The least expensive option where the rate is based on the distance of each ride and the total cost is adding together all desired rides which are priced based on distance and put on the schedule for a specified vehicle and driver. Accepting a deposit for the planned schedule of rides is optional and up to the company.
2. Hourly Service: less of a plan is needed beyond the desired start time, end time and origin location. A general idea of the destinations without specific times is important to know for the sake of potentially notifying each destination of the company's arrival, the number guests, and whether reservations are necessary based on the number guests as well as if parking in their lot while guests are being entertained is acceptable. The most expensive option where the rate is based on the amount of hour and may include distance surcharges if traveling beyond a certain amount of distance from the beginning of service until the end. Accepting a deposit for this service is standard.
3. Private driveshare service: a full plan is not necessary although if certain ride times are known, based on the availability, can be scheduled with more flexibility. Like the hourly service, a start and end time along with an origin location is needed. This option is less expensive overall than the hourly service option with less flexibility that the hourly service offers. It does not require a full plan like the by-the-ride service needs. Conditions regarding new requests that fall within the desired timeframe are detailed prior to accepting deposit.

If Prospect A requests a date with a fully free schedule, they have the ability to schedule any of the three options.

Step 2—Check the date for the availability for the prospect's desired vehicle and driver.

In this example, Prospect A chooses the by-the-ride service and schedules three rides attending two specified destinations for twelve o'clock noon, two o'clock, and five o'clock on June fifth.

Step 3—Schedule Prospect A's origin and destination address's for the desired date by including each address associated with teach reserved time of twelve o'clock noon, two o'clock, and five o'clock in the evening of June fifth and include Prospect A's full name and method of contact whether it be their phone number, mailing address, or email address along with the vehicle and driver assigned, as shown below:

### Vehicle A and Driver A for June Fifth

12:00 Customer A Origin location to Destination 1—(phone number/mailing address/email address)
2:00 Customer A Destination 1 to Destination 2
5:00 Customer A Destination 2 to Origin location

Prospect A is now Customer A. It is now known that on June fifth, Vehicle A and Driver A, between the hours of twelve o'clock and five o'clock, a new request cannot be scheduled for hourly service. New callers now have the option to schedule by-the-ride service or private driveshare service between the hours of twelve o'clock and five o'clock for June fifth with Vehicle A and Driver A.

Prospect B calls in for transportation on June fifth and was interested in hourly service from eleven o'clock in the morning until seven o'clock in the evening, as they did not have a set plan and were not interested in nor willing to schedule rides with the by-the-ride service option.

Step 4—request from Prospect B which destinations they were interested in visiting along with their origin location, without needing to know the exact time of each ride needed.

Since Prospect B's desired destinations seem to be a good fit for the already schedule rides of Customer A, based on the locations, continue to step 5.

Step 5—Offer Prospect B the option of being the private driveshare customer for the hours of twelve o'clock to five o'clock and let them know of the three rides scheduled with Customer A. Explain the condition of the new requests that may be received for the hours of twelve to five o'clock and the response time needed in order to approve of or deny those potential new requests based on their own potential plans and whether they can work with them or not.

Prospect B assess the other scheduled rides and understands the conditions if new, outside requests with specified times and destination they may come up within that timeframe between today and the day of service, and agree that the response is needed within a stated amount of hours if contacted by the company more than two days prior to the day of service and that the needed response time shortens to another specific amount of time to respond when within two days of the day of service, to either accept or deny that outside time and destination specific request made and understand that it will otherwise be automatically scheduled. For the hours of eleven o'clock in the morning until it would be time to leave for Customer A's twelve o'clock ride and from the time it takes to finish Customer A last ride at five o'clock until seven o'clock, they have the option to hire the service at an hourly rate and all other requests will be denied for that specific vehicle and driver.

Step 6—Also offer Prospect B to be the private driveshare customer from eleven o'clock until seven o'clock where new requests made between the entire timeframe will be attempted to be communicated from the company and maintain the conditions previously stated for the full time of their day and explain the difference in price.

Note: the private driveshare pricing models a cost per timeframe, as well as a cost per ride. For example, Company A charges thirty dollars to sixty dollars per ride, based on distance within a certain geographical zone for their by-the-ride service and sixty dollars per hour at an hourly rate with a fifty-five-mile limit before additional distance surcharges are applied. An example of private driveshare pricing could be one hundred dollars per four-hour timeframe plus the cost of each ride. In this example, the quote for being a private driveshare customer from twelve to five o'clock with the hourly service from approximately eleven to twelve o'clock and approximately five to seven o'clock, would be three hours at sixty dollars per hour and one-hundred and twenty-five dollars for five hours as the private driveshare customer, or a total of three hundred and five dollars plus the cost per ride. For private driveshare customers that accept many outside requests within their timeframe, the price per ride can be reduced to ten dollars to forty dollars per ride based on distance within the same zone the price per ride is forty dollars to sixty dollars per ride based on distance. I Customer A had never scheduled their rides and the schedule was wide open for Prospect B, the hourly cost from eleven to seven would be four hundred and eighty dollars. If Prospect B elected to be the private driveshare customer for the entirety of their desired time of service, the cost would be two-hundred dollars, or two, four hour timeframes at one-hundred dollars, plus the cost of the rides. Every outside request accepted by the private driveshare customer, whether previously established or newly accepted can initiate a reduction in their price per ride based on distance.

Prospect B accepts the terms and requests for the price of both quotes

Step 7 provide the quote for the desired hours they have the vehicle and driver to themselves for, along with for the hours of being private driveshare customers.

Prospect B elects to go with the private driveshare option for the entirety of their day and evening's service and sends a two hundred dollar deposit for Driver A and Vehicle A on June fifth.

Step 8-Schedule Prospect B's origin and destination address's for the date of June fifth and include Prospect B's name and method of contact (phone number; mailing address, email address) along with the vehicle and driver assigned, keeping Customer A's schedule intact as shown below:

Vehicle A and Driver A for June 5^{th}
11:00-7:00 Customer B-Private Driveshare Customer Origin Location and Contact
12:00 Customer A Origin location to Destination 1-(phone number/mailing address/email address)
2:00 Customer A Destination 1 to Destination 2
5:00 Customer A Destination 2 to Origin location
11:00-7:00 Customer B-Private Driveshare Customer

Prospect B is now Customer B

For the date of June fifth, between the hours of eleven o'clock in the morning and seven o'clock in the evening, there can only be by-the-ride customers scheduled and Customer B will be notified of any relevant new requests coming in for those hours.

1. The systematic process of acquiring, organizing, and executing the separate transportation of multiple groups and individuals seeking passenger transportation within a given day by the utilization of collecting deposits for a timeframe or multiple timeframes, allowing the group or individual making the timeframe deposit or deposits the ability to accept the transportation service's availability of times outside of and in between the already established decisive ride schedule, while also providing a degree of control over the potential new decisive ride requests from outside groups or individuals that may arise within their deposited timeframe or timeframes under the conditions that their acceptance or denial of such new requests is communicated within the stated amount of time set forth by the servicing company and that such conditions will automatically accept and schedule outside decisive requests after the time period for response has surpassed.
